(19) United States
(12) Patent Application Publication
(10) Pub. No.: US 2006/0170140 A1
(43) Pub. Date: Aug. 3, 2006

(54) Spring device, especially for the rail vehicle sector

(76) Inventors: Thorsten Menk, Lauenburg (DE); Hans-Harald Kielbasiewicz, Jesteburg (DE)

Correspondence Address: WILLIAM COLLARD;COLLARD & ROE, P.C., 1077 NORTHERN BOULEVARD, ROSLYN, NY, 11576, US

(21) Appl. No.: 10/548,346

(22) PCT Filed: May 26, 2004
(86) PCT No.: PCT/DE04/01088

§ 371 Date: Sep. 7, 2005

(30) Foreign Application Priority Data
Jun. 4, 2003 (DE) 103 25 507.9
Nov. 3, 2003 (DE) 103 51 110.5

(51) Int. Cl. B60G 11/62

(52) U.S. Cl. 267/35

(57) ABSTRACT

The invention relates to a spring device, above all for the rail vehicle sector, particularly for absorbing shocks between a bogie and a superstructure. The spring device encompasses a combination of at least three springs, i.e.: a first spring comprising a pneumatic cushioning diaphragm that is made of an elastomeric material, is provided especially with an embedded strengthening support, particularly in the form of a criss-crossly stacked diaphragm, is fixed to a support plate and a pneumatic spring seat, and encloses an air chamber which has an elastic volume and is connected especially to at least one air supply; a second spring that is disposed between the pneumatic spring seat of the pneumatic cushioning diaphragm and a base and comprises above all a layered spring with at least one elastomer layer, and a third spring that is located above the support plate as an elastic top bearing and comprises especially a layered spring with at least one elastomer layer.

The invention relates to a spring device, particularly for the rail vehicle sector, particularly, even more, for absorbing shocks between a bogie and a superstructure, consisting of a combination of at least three springs, namely:
a first spring comprising an air spring diaphragm made of elastomer material, which is particularly provided with an embedded reinforcement support, particularly, even more, in the form of a cross-layered diaphragm, whereby the air spring diaphragm is attached to a support plate, on the one side, and to an air spring seat, on the other side, and thereby encloses an air chamber that is elastic in volume, which particularly is connected with at least one air connector;
a second spring that is disposed between the air spring seat of the air spring diaphragm and a base structure and, in particular, comprises a layered spring having at least one elastomer layer; as well as
a third spring.

A spring device of this type is known from the patent EP 0 866 759 B1. The first air spring comprises, in particular, a cross-layered diaphragm (DE 29 04 522 A1). The second spring is affixed outside of the first spring, and in this connection extends from the support plate all the way to the base structure. The third spring, in contrast, is built in within the piston-shaped air spring seat, specifically with the simultaneous use of a pressure punch for the transfer of force. The second and third spring are, in particular, helical springs made of steel or an elastomer material. Furthermore, the use of an additional spring in the form of a layered spring is introduced.

With regard to the state of the art of helical springs and layered springs, supplemental reference is made to the two utility models AT 002 471 U1 and DE 296 20 721 U1, respectively.

In rail vehicles, the combination of a layered spring (primary spring module) and an air spring (secondary spring module) is of particular importance. Secondary spring modules primarily serve to ensure pneumatic bearing of the superstructure. Damping of the inherent vibrations guarantees a comfortable ride, since vibrations and travel noises are absorbed.

In the following, the problems of layered springs will be discussed in greater detail.

Soft, high layered springs tend towards unstable behavior when combined with air springs. In case of deflections, the characteristic lines demonstrate a degressive progression; the layered springs tip over. If the vertical force is maintained, these systems do not return to their starting position. This behavior is attributable to the fact of rigid clamping only on one side, and to the slanted position of the air spring seat on the additional spring side.

For the purpose of eliminating this set of problems, the new spring device is characterized, in accordance with the characterizing part of claim 1, in that the third spring is disposed above the support plate, as an elastic top bearing.

With this measure, the wear at the air spring seat is reduced, in addition.

Practical embodiments of the invention are named in claims 2 to 29.

The invention will now be explained on the basis of exemplary embodiments, making reference to drawings. These show:

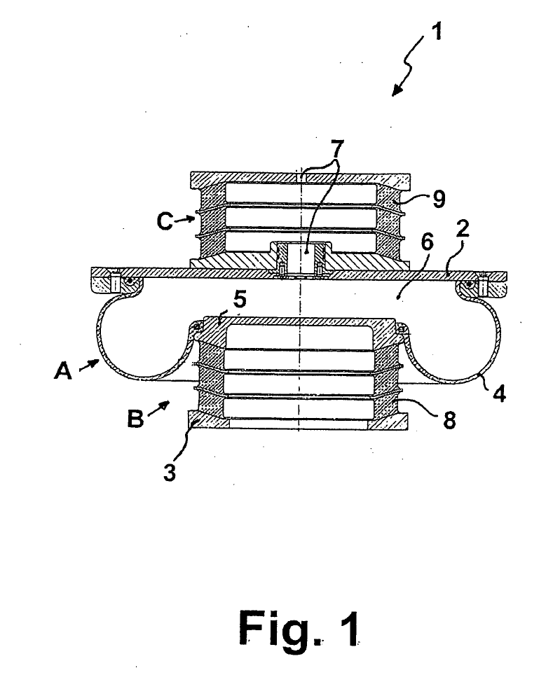

FIG. 1 a spring device having a half diaphragm and two layered springs having three elastomer layers each, as well as an air connector within the support plate;

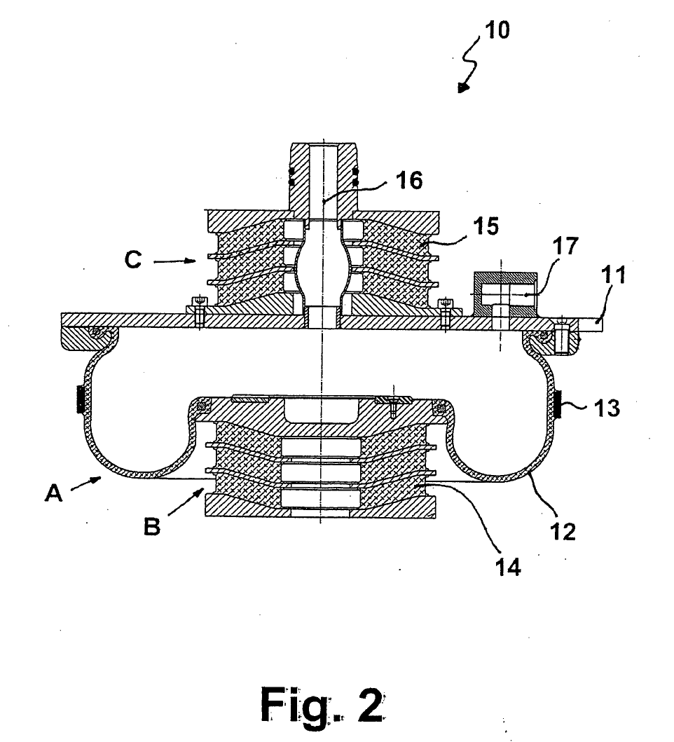

FIG. 2 a spring device having a belt diaphragm and two layered springs having three elastomer layers each, as well as two air connectors within the support plate;

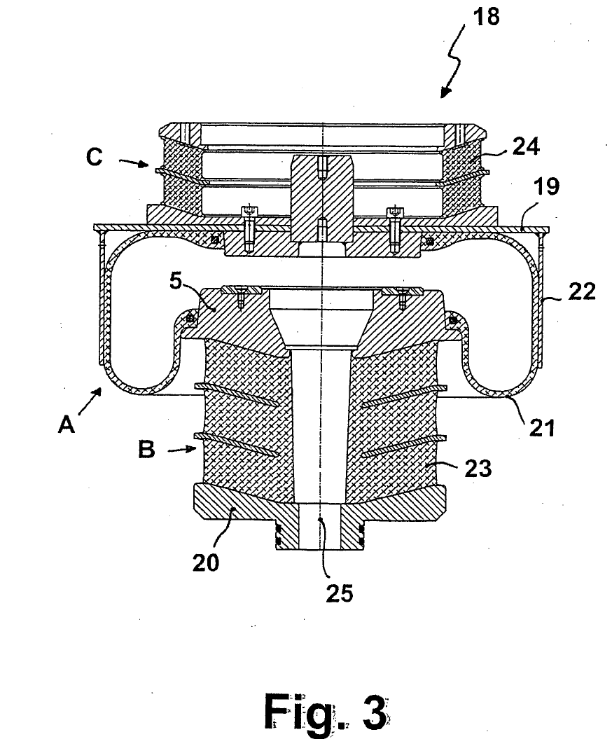

FIG. 3 a spring device having a rolled diaphragm having an outside guide and two layered springs having different layer structures, as well as an air connector within the base structure;

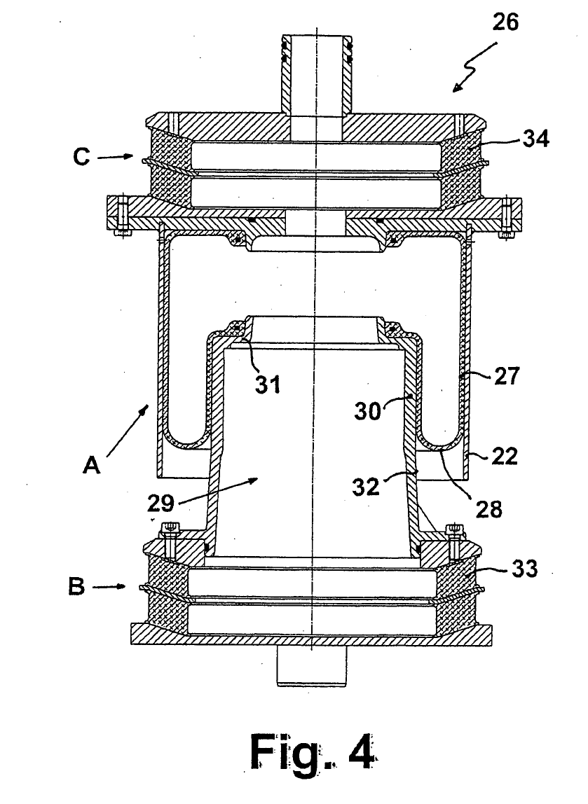

FIG. 4 a spring device having a rolled diaphragm having an outside guide and two layered springs having two elastomer layers each, as well as an air connector within the support plate;

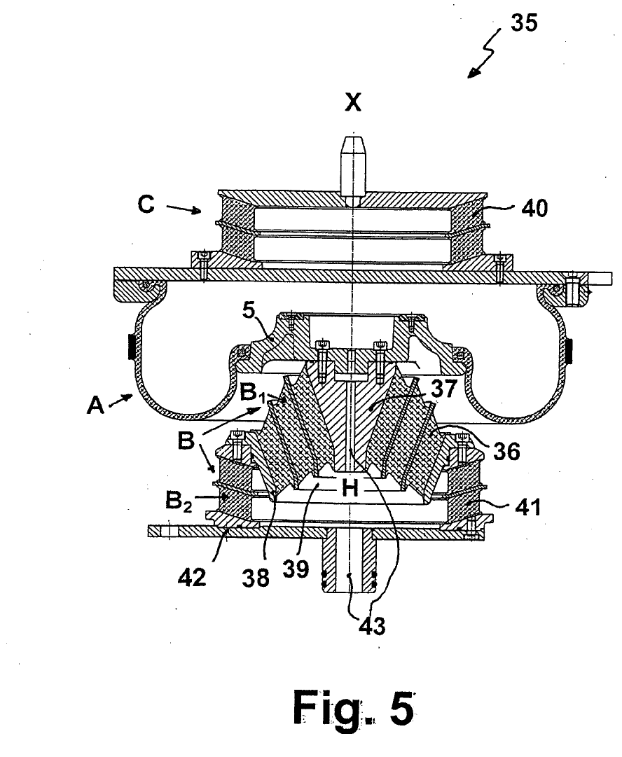

FIG. 5 a spring device having a belt diaphragm and three layered springs having partially different layer structures, as well as an air connector within the base structure;

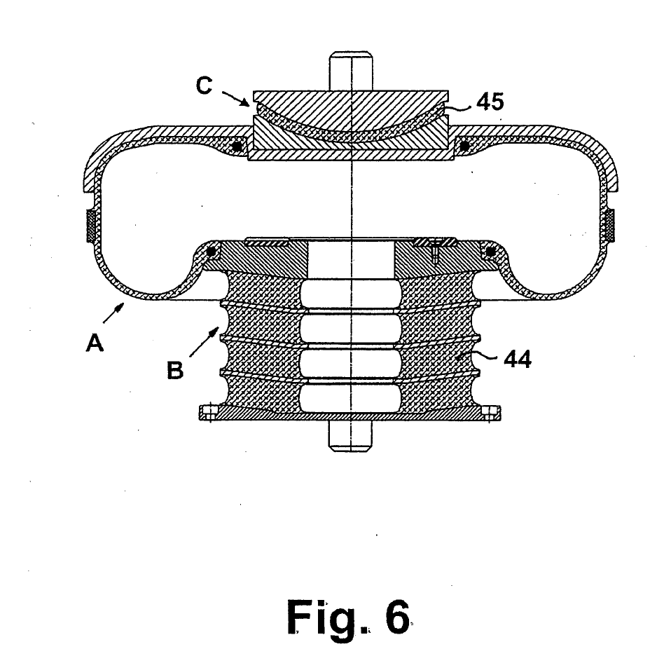

FIG. 6 a spring device having a belt diaphragm having two layered springs having different layer structures, whereby the top bearing is configured as a ball joint;

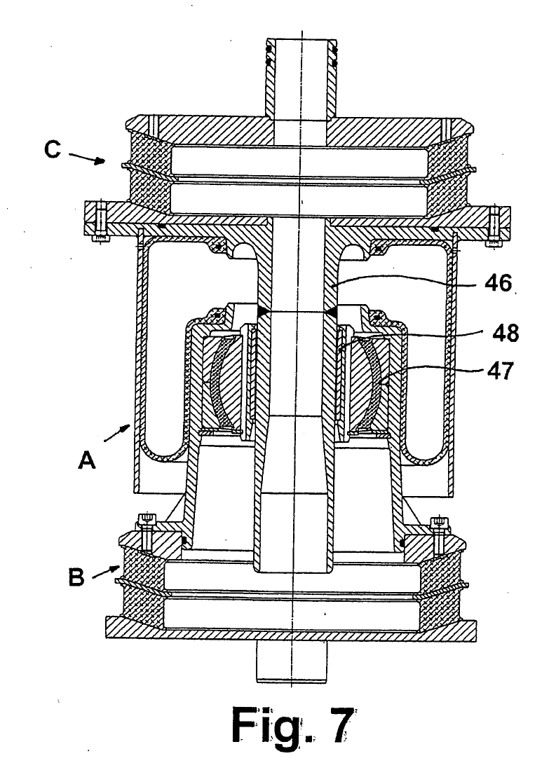

FIG. 7 a spring device having a rolled diaphragm having an outside guide and two layered springs having two elastomer layers each, as well as a guide rod having a ball joint and a slide bushing.

FIG. 1 shows a spring device 1 having a first spring A, comprising an air spring diaphragm 4 made of elastomer material, in the form of a half diaphragm. The air spring diaphragm is attached to a support plate 2, on the one side, and to an air spring seat 5, on the other side, and thereby encloses an air chamber 6 that is elastic in volume. With regard to the diaphragm attachment, reference is made to the general state of the art, for example to DE 40 11 517 A1. Here, the air spring seat is configured as an attachment plate.

The second spring B is a layered spring 8 having three elastomer layers in the form of a metal/elastomer composite, and has a slightly angled layer progression, in this connection. The layered spring forms a one-piece total composite with the air spring seat 5 and the base structure 3.

The third spring C as an elastic top bearing above the support plate 2 is also configured as a layered spring 9 having three elastomer layers, in the form of a metal/elastomer composite, specifically with a slightly angled layer progression. In this connection, the support plate has an air connector 7 that runs within the spring C.

FIG. 2 shows a spring device 10 having a first spring A, the air spring diaphragm 12 of which is provided with a reinforcement strip 13 on the outside, specifically forming a belt diaphragm.

The second spring B and third spring C, as layered springs 14 and 15, respectively, form a metal/elastomer composite with, once again, three elastomer layers each, whereby the two springs have an essentially horizontal as well as a slightly angled layer progression, in segments.

Here, the support plate 11 has two air connectors. One air connector 16 runs within the spring C. The additional air connector 17, in contrast, is disposed outside the spring C.

According to FIG. 3, the spring device 18 comprises a first spring A, the air spring diaphragm 21 of which is configured as a rolled diaphragm and is additionally provided with an outside guide 22.

The second spring B is a layered spring 23 having a total of three elastomer layers, with a similar progression as in the exemplary embodiment according to FIG. 2. The base structure 20 and the air spring seat 5 as the attachment plate have a continuous air connector 25 that runs within the spring B.

The third spring C is also a layered spring 24 having a total of two elastomer layers, with a similar progression as in the case of the exemplary embodiment according to claim 1.

FIG. 4 shows a spring device 26 having a first spring A, comprising an air spring diaphragm 27 in the form of a rolled diaphragm having an outside guide 22. The air spring seat 29 is configured as a piston 30 here, which has an attachment region 31 and a roll-off surface 32. In this connection, the rolled fold 28 of the air spring diaphragm corresponds with the roll-off surface of the piston.

The second spring B and third spring C, as layered springs 33 and 34, respectively, for a metal/elastomer composite, in each instance, having two elastomer layers.

With regard to the air connector that runs within the spring C, reference is made to the exemplary embodiment according to FIG. 1.

According to FIG. 5, the spring device 35 comprises a first spring A, the air spring diaphragm of which is configured as a belt diaphragm (FIG. 2).

The second spring B, as a layered spring 36 and 41, here comprises a spring system B₁ and B₂, whereby the spring B₁ is a conical spring having three elastomer layers, and the spring B₂ is a layered spring having two elastomer layers, with a slightly angled layer progression. The conical spring B₁ consists of a core 37, an outer sleeve 38, and a base chamber 39, which is configured under a core offset H. The conical spring B₁ stands in connection with the air spring seat 5, specifically by means of a screw connection with the core 37, while the layered spring B₂ is connected with the base structure 42.

The third spring C, as a layered spring 40, comprises two elastomer layers here.

The base structure 42 and the air spring seat 5 have a continuous air connector 43 that runs within the second spring B, specifically within the core 37 here.

According to FIG. 6, the first spring A comprises a belt diaphragm (FIG. 2, 5). The second spring B is a layered spring 44 having a total of four elastomer layers. The third spring C is also a layered spring 45, which has a curved layer progression here, within the scope of a single elastomer layer, particularly with the formation of a ball joint.

The spring device according to FIG. 7 is provided with a guide rod 46, a ball joint 47, and a slide bushing 48, in contrast to the spring device according to FIG. 4. With regard to the related technology, reference is made to the patent EP 0 897 489 B1.

In the case of the exemplary embodiments according to FIG. 1 to FIG. 7, all the springs A, B, B₁, B₂, and C have a common center plane, i.e. axis of rotation X (FIG. 5).

### Reference Symbol List

1 spring device
2 support plate with air connector
3 base structure
4 air spring diaphragm (half diaphragm)
5 air spring seat (attachment plate)
6 volume-elastic air chamber
7 air connector
8 layered spring having three elastomer layers
9 layered spring having three elastomer layers
10 spring device
11 support plate with two air connectors
12 air spring diaphragm (belt diaphragm)
13 reinforcement strip
14 layered spring having three elastomer layers
15 layered spring having three elastomer layers
16 air connector
17 air connector
18 spring device
19 support plate without air connector
20 base structure with air connector
21 air spring diaphragm (rolled diaphragm)
22 outside guide
23 layered spring having three elastomer layers
24 layered spring having three elastomer layers
25 air connector
26 spring device
27 air spring diaphragm (rolled diaphragm)
28 rolled fold
29 air spring seat
30 piston (roll-off piston, plunger piston)
31 attachment region
32 roll-off surface
33 layered spring having two elastomer layers
34 layered spring having two elastomer layers
35 spring device
36 layered spring (conical spring) having three elastomer layers
37 core
38 outer sleeve
39 base chamber
40 layered spring having two elastomer layers
41 layered spring having two elastomer layers
42 base structure with air connector
43 air connector
44 layered spring having four elastomer layers
45 layered spring (ball joint)
46 guide rod (piston rod)
47 ball joint
48 slide bushing
A first spring (air spring)
B second spring (layered spring)
B₁ second spring (layered spring) within the framework of a spring system
B₂ second spring (layered spring) within the framework of a spring system
C third spring (layered spring)
H core offset
X center plane, i.e. axis of rotation

1. Spring device (1, 10, 18, 26, 35), particularly for the rail vehicle sector, particularly, even more, for absorbing shocks between a bogie and a superstructure, consisting of a combination of at least three springs (A, B, C), namely:
a first spring (A) comprising an air spring diaphragm (4, 12, 21, 27) made of elastomer material, which is particularly provided with an embedded reinforcement support, particularly, even more, in the form of a cross-layered diaphragm, whereby the air spring diaphragm is attached to a support plate (2, 11, 19), on the one side, and to an air spring seat (5, 29), on the other side, and thereby encloses an air chamber (6) that is elastic in volume, which particularly is connected with at least one air connector (7, 16, 17, 25, 43);
a second spring (B) that is disposed between the air spring seat (5, 29) of the air spring diaphragm (4, 12, 21, 27) and a base structure (3, 20, 42) and, in particular, comprises a layered spring (8, 14, 23, 33, 36, 41, 44) having at least one elastomer layer; as well as
a third spring (C);
wherein
the third spring (C) is disposed above the support plate (2, 11, 19), as an elastic top bearing.

2. Spring device according to claim 1, wherein the third spring (C) comprises a layered spring (9, 15, 24, 34, 40, 45) having at least one elastomer layer.

3. Spring device according to claim 2, wherein the layered spring (9, 15, 24, 34, 40, 45) of the third spring (C) is a metal/elastomer composite.

4. Spring device according to claim 2, wherein the layered spring (9, 15, 24, 34, 40, 45) of the third spring (C) is a plastic/elastomer composite, whereby the plastic demonstrates metal-like properties, preferably on the basis of polyphenylene ether.

5. Spring device according to claim 2, wherein the layered spring (9, 15, 24, 34, 40) of the third spring (C) demonstrates an essentially horizontal and/or slightly angled layer progression.

6. Spring device according to claim 2, wherein the layered spring (9, 15, 24, 34, 40) of the third spring (C) has at least two elastomer layers.

7. Spring device according to claim 6, wherein two or three elastomer layers are present.

8. Spring device according to claim 2, wherein the layered spring (45) of the third spring (C) has a curved layer progression, particularly forming a ball joint.

9. Spring device according to claim 8, wherein only a single elastomer layer is present.

10. Spring device according to claim 1, wherein the air spring seat (5) of the first spring (A) is configured as an attachment plate.

11. Spring device according to claim 10, wherein the air spring diaphragm (4) is a half diaphragm.

12. Spring device according to claim 10, wherein the air spring diaphragm (12) is provided with a reinforcement strip (13) on the outside, specifically forming a belt diaphragm.

13. Spring device according to claim 10, wherein the air spring diaphragm (21) is a rolled diaphragm.

14. Spring device according to claim 1, wherein the air spring seat (29) of the first spring (A) is configured as a piston (30) that has an attachment region (31) and a roll-off surface (32).

15. Spring device according to claim 14, wherein the air spring diaphragm (27) is a rolled diaphragm whose rolled fold (28) corresponds to the roll-off surface (32) of the piston (30).

16. Spring device according to claim 13, wherein rolled diaphragm (21, 27) is provided with an outside guide (22).

17. Spring device according to claim 1, wherein the layered spring (8, 14, 23, 33, 36, 41, 44) of the second spring (B) is a metal/elastomer composite.

18. Spring device according to claim 1, wherein the layered spring (8, 14, 23, 33, 36, 41, 44) of the second spring (B) is a plastic/elastomer composite, whereby the plastic demonstrates metal-like properties, preferably on the basis of polyphenylene ether.

19. Spring device according to claim 1, wherein the layered spring (8, 14, 23, 33, 41, 44) of the second spring (B) demonstrates an essentially horizontal and/or slightly angled layer progression.

20. Spring device according to claim 1, wherein the layered spring (36) of the second spring (B) is configured as a conical spring.

21. Spring device according to claim 1, wherein the layered spring (36, 41) of the second spring (B) is configured as a spring system (B₁, B₂), comprising a conical spring (B₁, 36) and a layered spring (B₂, 41) that demonstrates an essentially horizontal and/or slightly angled layer progression.

22. Spring device according to claim 20, wherein the conical spring (B₁, 36) comprises a core (37), an outer sleeve (38), and a base chamber (39), which is configured under a core offset (H).

23. Spring device according to claim 21, wherein the conical spring (B₁, 36) stands in connection with the air spring seat (5), while the layered spring (B₂, 41) is connected with the base structure (42) with the essentially horizontal and/or slightly angled layer progression.

24. Spring device according to claim 1, wherein the layered spring (8, 14, 23, 33, 36, 41, 44) of the second spring (B) has at least two elastomer layers.

25. Spring device according to claim 24, wherein two to four elastomer layers are present.

26. Spring device according to claim 1, wherein all of the springs (A, B, B₁, B₂, C) demonstrate a common center plane, i.e. axis of rotation (X).

27. Spring device according to claim 1, wherein the support plate (2, 11) has an air connector (7, 16) that runs within the third spring (C).

28. Spring device according to claim 27, wherein the support plate (11) possesses an additional air connector (17) that is disposed outside of the third spring (C).

29. Spring device according to claim 1, wherein the base structure (20, 42) and the air spring seat (5) demonstrate a continuous air connector (25, 43) that runs within the second spring (B).
